(19) United States
(12) Patent Application Publication
(10) Pub. No.: US 2008/0216684 A1
(43) Pub. Date: Sep. 11, 2008

(54) Printing control apparatus and printing apparatus

(75) Inventors: Masako Horai, Matsumoto-shi (JP); Susumu Murayama, Shiojiri-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/075,173

(22) Filed: Mar. 10, 2008

(30) Foreign Application Priority Data
Mar. 8, 2007 (JP) 2007-58752

(51) Int. Cl. B41F 1/40

(52) U.S. Cl. 101/202

(57) ABSTRACT

In an aspect, a first ink amount relating to the yellow ink is smaller than both a second ink amount relating to the cyan ink and a third ink amount relating to the magenta ink.

In another aspect, a first total increase amount is larger than both a second total increase amount and a third total increase amount. The first total increase amount is a total increase amount of inks other than the yellow ink relating to a black yellow gradation. The second total increase amount is a total increase amount of inks other than the cyan ink relating to a black cyan gradation. The third total increase amount is a total increase amount of inks other than the magenta ink relating to a black magenta gradation.

In another aspect, a first lowest brightness is lower than both a second lowest brightness and a third lowest brightness. The first lowest brightness is lowest brightness of color to be printed without using black ink on a black yellow gradation. The second lowest brightness is lowest brightness of color to be printed without using black ink on a black cyan gradation. The third lowest brightness is lowest brightness of color to be printed without using black ink on a black magenta gradation.

### CROSS-REFERENCE TO RELATED APPLICATIONS

The present application claims the priority based on Japanese Patent Application No. 2007-58752 filed on Mar. 8, 2007, the disclosure of which is hereby incorporated by reference in its entirety.

### BACKGROUND

1. Technical Field

This invention relates to a printing control apparatus and a printing apparatus.

2. Description of the Related Art

From the past, printing has been performed using a plurality of inks (for example, a cyan ink, a magenta ink, a yellow ink, and a black ink). With this kind of printing, the ink amount used per unit area of each ink is set by considering various conditions (hereinafter, the ink amount indicates the amount of ink used per unit area). For example, the graininess when using high density inks or the ink absorption capacity by the printing medium are considered.

To reproduce a color with lower brightness than a color reproduced with a certain ink amount, sometimes additional ink is used. For example, additional black ink decreases the brightness. Meanwhile, there is a limit to the ink absorption capacity of a printing medium, so there are cases when it is not possible to add a large amount of ink (for example, when reproducing a high saturation color). In such a case, if a high density ink is used (black ink, for example), it is possible to lower the brightness using an additional small ink amount. However, the use of high density ink can cause the graininess to become rough.

### SUMMARY

An object of the present invention is to provide technology that is capable of improving the graininess when the brightness is lowered.

In a first aspect, a printing apparatus for printing using a plurality of inks includes a printing control module. The printing control module is configured to control respective amounts of the plurality of inks. The plurality of inks includes a cyan ink, a magenta ink and a yellow ink. The printing control module controls the respective amounts of the plurality of inks so as to meet the following condition: a first ink amount is smaller than both a second ink amount and a third ink amount. The first ink amount is an amount of the yellow ink per unit area when printing a first color. The first color has the same or almost the same hue as hue of the yellow ink and brightness that is nearly a median of a domain of the brightness. The second ink amount is an amount of the cyan ink per unit area when printing a second color. The second color has the same or almost the same hue as hue of the cyan ink and brightness that is nearly the median of the domain of the brightness. The third ink amount is an amount of the magenta ink per unit area when printing a third color. The third color has the same or almost the same hue as hue of the magenta ink and brightness that is nearly the median of the domain of the brightness. In this aspect, the brightness of the first color may be the same as the median of the domain of the brightness. The brightness of the second color may be the same as the median of the domain of the brightness. The brightness of the third color may be the same as the median of the domain of the brightness.

In a second aspect, a printing apparatus for printing using a plurality of inks includes a printing control module. The printing control module is configured to control respective amounts of the plurality of inks. The plurality of inks includes a cyan ink, a magenta ink, and a yellow ink. The printing control module controls respective amounts of the plurality of inks so as to meet the following condition: a first ink amount is smaller than both a second ink amount and a third ink amount. The first ink amount is an amount of the yellow ink per unit area when printing a first color. The first color has the same or almost the same hue as hue of the yellow ink and highest saturation. The second ink amount is an amount of the cyan ink per unit area when printing a second color. The second color has the same or almost the same hue as hue of the cyan ink and highest saturation. The third ink amount is an amount of the magenta ink per unit area when printing a third color. The third color has the same or almost the same hue as hue of the magenta ink and highest saturation.

In a third aspect, a printing apparatus for printing using a plurality of inks includes a printing control module. The printing control module is configured to control respective amounts of the plurality of inks. The plurality of inks includes a cyan ink, a magenta ink, and a yellow ink. The printing control module controls the respective amounts of the plurality of inks so as to meet the following condition: a first ink amount is smaller than both a second ink amount and a third ink amount. The first ink amount is maximum ink amount of the yellow ink. The second ink amount is maximum ink amount of the cyan ink. The third ink amount is maximum ink amount of the magenta ink. The first, the second and the third ink amount respectively represents maximum ink amount per unit area in an overall color reproduction range of printing.

According to these aspects, the first ink amount relating to the yellow ink is set so as to be smaller than both the second ink amount relating to the cyan ink and the third ink amount relating to the magenta ink. Then, it is possible to improve the graininess by increasing the ink amount of another ink (for example, a light ink) different from the yellow ink when reproducing a yellow color whose brightness is decreased slightly from the yellow color whose yellow ink amount is set to the first ink amount.

In a fourth aspect, a printing apparatus for printing using a plurality of inks includes a printing control module. The printing control module is configured to control respective amounts of the plurality of inks. The plurality of inks includes a cyan ink, a magenta ink, a yellow ink, and a black ink. The printing control module controls the respective amounts of the plurality of inks so as to meet the following condition: a first lowest brightness is lower than both a second lowest brightness and a third lowest brightness when printing a black yellow gradation, a black cyan gradation and a black magenta gradation.

The first lowest brightness is lowest brightness of color to be printed without using black ink on the black yellow gradation. The black yellow gradation is a gradation in which a color changes from a yellow color of interest to a black color. The yellow color of interest has the same or almost the same hue as hue of the yellow ink and brightness that is nearly a median of a domain of the brightness.

The second lowest brightness is lowest brightness of color to be printed without using black ink on the black cyan gradation. The black cyan gradation is a gradation in which a color changes from a cyan color of interest to the black color. The cyan color of interest has the same or almost the same hue as hue of the cyan ink and brightness that is nearly a median of the domain of the brightness.

The third lowest brightness is lowest brightness of color to be printed without using black ink on the black magenta gradation. The black magenta gradation is a gradation in which a color changes from a magenta color of interest to the black color. The magenta color of interest has the same or almost the same hue as hue of the magenta ink and brightness that is nearly a median of the domain of the brightness.

In this aspect, the brightness of the yellow color of interest may be the same as the median of the domain of the brightness. The brightness of the cyan color of interest may be the same as the median of the domain of the brightness. The brightness of the magenta color of interest may be the same as the median of the domain of the brightness.

According to this aspect, with the black yellow gradation, a darker color than with the black cyan gradation and with the black magenta gradation is printed without using black ink, so when reproducing a yellow color whose brightness is slightly decreased from the yellow color of interest, it is possible to improve the graininess.

Note that this invention can be implemented in various forms including, for example, a printing apparatus control method and apparatus, a printing method and apparatus, a computer program to implement the functions of those methods or apparatuses, a recording medium on which is recorded that computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is an explanatory drawing showing a printing device as an embodiment;

FIG. 2 is an explanatory drawing of an example of the lookup table 230;

FIGS. 3A-3C are graphs showing an example of the ink amount correlated to colors on the three lines including the white vertex VW for the color cube CC; and

FIGS. 4A-4C are graphs showing an example of the ink amount correlated to the colors on the three lines DL1, DL2, and DL3 of the color cube CC.

### DESCRIPTION OF THE PREFERRED EMBODIMENT

The embodiments of the invention are described in the following sequence.

### A. First Embodiment

### B. Variations:

### A. First Embodiment

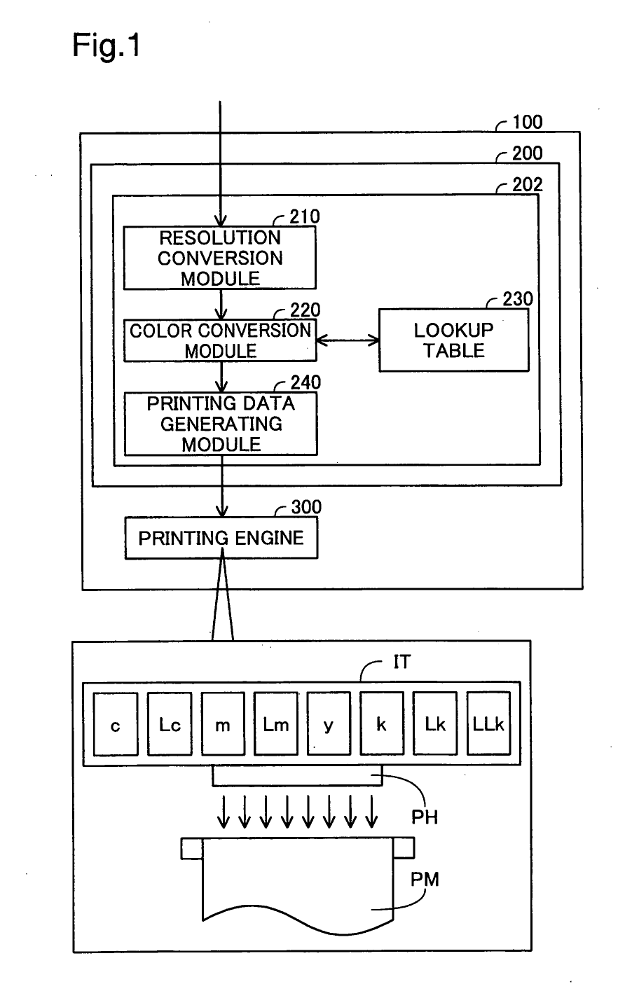

FIG. 1 is an explanatory drawing showing a printing device as an embodiment of the invention. This printing device 100 includes a printing control device 200, and a printing engine 300 controlled by this printing control device 200.

The printing engine 300 is a printing mechanism that executes printing using printing data supplied from the printing control device 200. With the embodiment of FIG. 1, the printing engine 300 includes an ink tank IT and a printing head PH. The printing head PH performs printing by ejecting ink drops onto a printing medium PM using ink stored in the ink tank IT.

With this embodiment, eight types of ink are stored in the ink tank IT. These inks are cyan ink c, light cyan ink Lc, magenta ink m, light magenta ink Lm, yellow ink y, black ink k, first light black ink Lk, and second light black ink LLk. The light cyan ink Lc has substantially same hue as the cyan ink c, and lower density than that of the cyan ink c (specifically, brighter). The light magenta ink Lm has substantially same hue as the magenta ink m, and lower density than that of the magenta ink m. The first light black ink Lk is an achromatic ink with a lower density than that of the black ink k. The second light black ink LLk is an achromatic ink that has an even lower density than that of the first light black ink Lk.

The reflection density can be used for comparison of the ink densities. As a method of measuring the reflection density, the following method can be used. Specifically, the method includes ejecting ink for each equal amount on the same printing medium, and measuring the density for each of these using a density meter.

The printing control device 200 is a general purpose computer that includes a CPU and memory (not illustrated). The printing control device 200 includes a printing control module 202. This printing control module 202 includes a resolution conversion module 210, a color conversion module 220, a printing data generating module 240, and a lookup table 230. Each of the modules 210, 220, and 240 is a program that is executed by the CPU (not illustrated). The lookup table 230 is stored in advance in the memory (not illustrated). The printing control module 202 is often implemented in the printing control device 200 as a printer driver. Also, as is described later, the printing engine 300 is controlled by the printing control module 202.

Image data for printing is supplied to the printing control module 202 (hereafter, this image data is also called “input image data”). For example, input image data is supplied from an image processing application (not illustrated) to the printing control module 202. Also, the input image data is supplied to the printing control module 202 from a removable memory card (not illustrated) according to user instructions. This kind of input image data can be expressed with various color systems. With this embodiment, the RGB color (red, green, blue) system will be used.

The resolution conversion module 210 converts the resolution (pixel density) of the supplied input image data to the printing resolution. The image data that underwent resolution conversion in this way is still expressed by the three color components of RGB. Next, the color conversion module 220 converts each pixel's RGB image data (first image data) into multitone data (second image data) while referencing the lookup table 230. The multitone data (second image data correlates to the respective amounts of the plurality of inks that can be used by the printing engine 300. Generally, the input image data is expressed using a color system (also called the “input color system”) that is different from the color system with which the color is expressed by the ink amount (also called the “ink color system”). The color conversion module 220 converts the color system of the image data from the input color system into the ink color system (converts the first image data expressed with the input color system into the second image data expressed with the ink color system). By doing this, the respective ink amounts of the plurality of inks are set (controlled) for printing. The correspondence relationship between the input color system and the ink color system is defined by the lookup table 230.

The printing data generating module 240 generates printing data from the image data expressed with the ink color system. As the printing data format, any format suited for the printing engine 300 may be employed. For example, the printing data generating module 240 generates printing data that expresses the recording status of the dots of each ink by executing so-called halftone processing. The printing data may include various commands that control the printing engine 300.

Note that the ink amount expressed with the ink color system, specifically the ink amount determined by the lookup table 230, expresses the ink amount per unit area. Also, this ink amount expresses the average ink amount. For example, when reproducing a certain color using halftone processing, a partial area where ink dots are recorded and a partial area where there are no ink dots are generated within the area showing that color on the printing medium. In this case, halftone processing is executed such that the average ink amount within that color area corresponds to the ink amount expressed with the ink color system.

The generated printing data is supplied from the printing control module 202 (printing data generating module 240) to the printing engine 300. The printing engine 300 executes printing according to the received printing data.

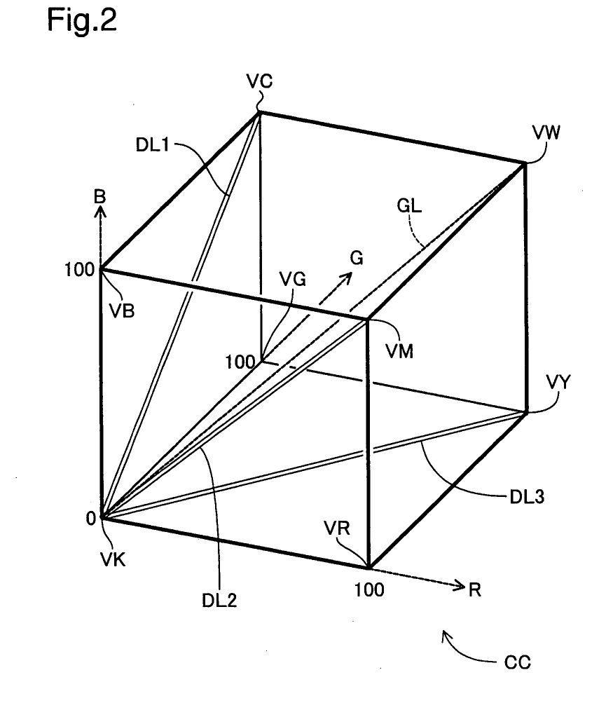

FIG. 2 is an explanatory drawing of an example of the lookup table 230. A color cube CC is shown in FIG. 2. This color cube CC shows a cube expressed by respective tone values (0 to 100%) of the three color components R (red), G (green), and B (blue) for the input color system. The three sides extending from one vertex VK and crossing at right angle each other indicate the R axis, the G axis, and the B axis in the color cube CC respectively. The color represented by the input image data (hereafter called the “input color”) is represented by a particular point within this color cube CC. Here, the color reproduced on the printing medium PM is called the “reproduction color.” The lookup table 230 indicates the correspondence relationship between the input color and the reproduction color. Specifically, the ink amount of each ink for reproducing the reproduction color is associated with that input color within the color cube CC. In this way, the reproduction color is represented in the ink color system.

At the eight vertices of the color cube CC, a symbol is attached respectively. Each symbol includes the character “V” followed by the character indicating the color.

The color of the origin point VK, specifically, the black vertex VK (R=G=B=0%) is black.

The color of the red vertex VR (R=100%, G=B=0%) is red.

The color of the green vertex VG (G=100%, R=B=0%) is green.

The color of the blue vertex VB (B=100%, R=G=0%) is blue.

The color of the cyan vertex VC (G=B=100%, R=0%) is cyan.

The color of the magenta vertex VM (R=B=100%, G=0%) is magenta.

The color of the yellow vertex VY (R=G=100%, B=0%) is yellow.

The color of the white vertex VW (R=G=B=100%) is white.

Note that where the straight line connecting the black vertex VK and the white vertex VW is termed an achromatic line GL. The distance between any particular point in the color cube CC and the achromatic line GL can be used as an index of saturation of the particular point. Also, where a point projected vertically on the achromatic line GL from the particular point is termed a projection point. The distance between the black vertex VK and the projection point can be used as an index of brightness of the particular point. Also, the direction from the projection point to the particular point in the color cube CC can be used as an index of hue of the particular point.

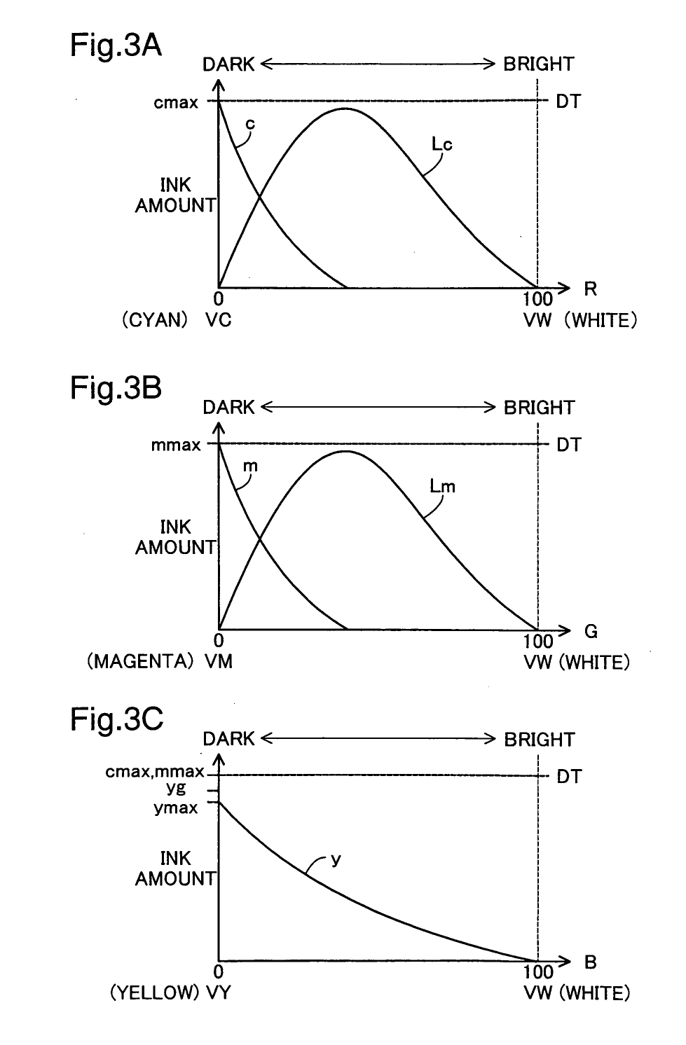

FIGS. 3(A)-3(B) are graphs showing an example of the ink amount associated with the color on three lines including the white vertex VW in the color cube CC. The horizontal axis indicates the position on the line, and the vertical axis indicates the ink amount. Also, the duty ink amount DT (hereafter also referred to as “duty DT”) indicates the maximum value of the total ink amount that can be ejected on the printing medium PM. This kind of duty DT is determined through experimentation so as to obtain a suitable printing result. Also, the maximum value of the total ink amount of all inks in the overall color reproduction range is usually set to be the same as this duty DT. Note that this kind of duty (allowed maximum ink amount) is also set for each ink (omitted in the drawing). Specifically, the duty is also set for the ink amount of each ink respectively. Each ink duty is also determined by experimentation.

FIG. 3A shows the VC-VW line. The position on this line is represented by the tone value of the red component R (the horizontal axis indicates the tone value of the red component R). The color on this line varies between the high saturation cyan (VC) and maximum brightness white (VW). Here, the larger the red component R, the higher the brightness is. Also, the color on this line is reproduced by using the cyan ink c and the light cyan ink Lc.

In the part of the range where the red component R is small, the ink amount of the cyan ink c increases as the red component R decreases. In the part of the range where the red component R is large, the cyan ink c is not used. Meanwhile, the light cyan ink Lc is used in a range where the red component R is greater than zero and the red component R is less than the maximum value (100%). The ink amount of the light cyan ink Lc is represented by the smooth curve. The both ends (R=0, 100%) of the curve are zero, and the curve has one peak between them.

The relatively bright colors (colors near the white vertex VW) are reproduced by using the light cyan ink Lc without using the cyan ink c. As a result, it is possible to improve the graininess of bright cyan. Note that the color of the white vertex VW is reproduced without ejecting ink.

Meanwhile, relatively dark (high saturation) colors (colors near the cyan vertex VC) are reproduced by using the cyan ink c in addition to the light cyan ink Lc. As a result, it is possible to reproduce high saturation cyan. Note that with this embodiment, the highest saturation cyan color is associated with the cyan vertex VC. Furthermore, the maximum ink amount of the cyan ink c in the overall color reproduction range is the ink amount at this cyan vertex VC. Furthermore, to reproduce the highest saturation cyan color, the ink amount of the cyan ink c among the plurality of inks is set to the largest value. Hereafter, the color for which the ink amount of the cyan ink c is the maximum in the overall color reproduction range is termed the maximum cyan color. Also, that maximum ink amount is termed the cyan maximum ink amount cmax. With this embodiment, the cyan maximum ink amount cmax is set to be the same as the duty DT. However, the cyan maximum ink amount cmax may be smaller than the duty DT. In either case, for colors reproduced with the ink amount of the cyan ink c smaller than the cyan maximum ink amount cmax, it is possible to use another ink of the amount decreased from the maximum ink amount cmax.

FIG. 3B shows the VM-VW line. The position on this line is represented by the tone value of the green component G (the horizontal axis indicates the tone value of the green component G). The color on this line varies between the high saturation magenta (VM) and white (VW). Here, the larger the green component G, the higher the brightness is. Also, the color on this line is reproduced by using the magenta ink m and the light magenta ink Lm.

The ink amounts of the magenta ink m and the light magenta ink Lm are respectively set in the same manner as the ink amounts of the cyan ink c and the light cyan ink Lc shown in FIG. 3A. Specifically, relatively bright colors (colors near the white vertex VW) are reproduced by using the light magenta ink Lm without using the magenta ink m. Meanwhile, relatively dark (high saturation) colors (colors near the magenta vertex VM) are reproduced by using the magenta ink m in addition to the light magenta ink Lm.

Note that with this embodiment, the highest saturation magenta color is associated with the magenta vertex VM. Furthermore, the maximum ink amount of the magenta ink m in the overall color reproduction range is the ink amount at this magenta vertex VM. Furthermore, to reproduce the highest saturation magenta color, the ink amount of the magenta ink m among the plurality of inks is set to the largest value. Hereafter, the color for which the ink amount of the magenta ink m is the maximum in the overall color reproduction range is termed the maximum magenta color. Also, that maximum ink amount is termed the magenta maximum ink amount mmax. With this embodiment, the magenta maximum ink amount mmax is set to be the same as the duty DT. However, the magenta maximum ink amount mmax may be smaller than the duty DT. In either case, for color reproduced with the ink amount of the magenta ink m smaller than the magenta maximum ink amount mmax, it is possible to use another ink of the amount decreased from the maximum ink amount mmax.

FIG. 3C shows the VY-VW line. The position on this line is represented by the tone value of the blue component B (the horizontal axis indicates the tone value of the blue component B). The color on this line varies between the high saturation yellow (VY) and white (VW). Here, the larger the blue component B, the higher the brightness is. Also, the color on this line is reproduced by using the yellow ink y.

The ink amount of the yellow ink y increases as the blue component B decreases. Also, except for the color of the white vertex VW (where the blue component B is 100%), the ink amount of the yellow ink y is greater than zero.

With this embodiment, relatively bright colors (colors near the white vertex VW) are also reproduced using the yellow ink y. The reason for this is that the yellow ink y is brighter (lower in density) than both the cyan ink c and the magenta ink m, so ink dots of the yellow ink y tend not to stand out visually.

Note that with this embodiment, the highest saturation yellow color is associated with the yellow vertex VY. Furthermore, the maximum ink amount of the yellow ink y in the overall color reproduction range is the ink amount at this yellow vertex VY. Furthermore, to reproduce the highest saturation yellow color, the ink amount of the yellow ink y among the plurality of inks is set to the largest value. Hereafter, the color for which the ink amount of the yellow ink y is the maximum in the overall color reproduction range is termed the maximum yellow color. Also, that maximum ink amount is termed the yellow maximum ink amount ymax. For colors reproduced with the ink amount of the yellow ink y smaller than the yellow maximum ink amount ymax, it is possible to use another ink of the amount decreased from the maximum ink amount ymax. Note that with this embodiment, the yellow maximum ink amount ymax is set to a value smaller than both the cyan maximum ink amount cmax and the magenta maximum ink amount mmax. The reason for this is described later.

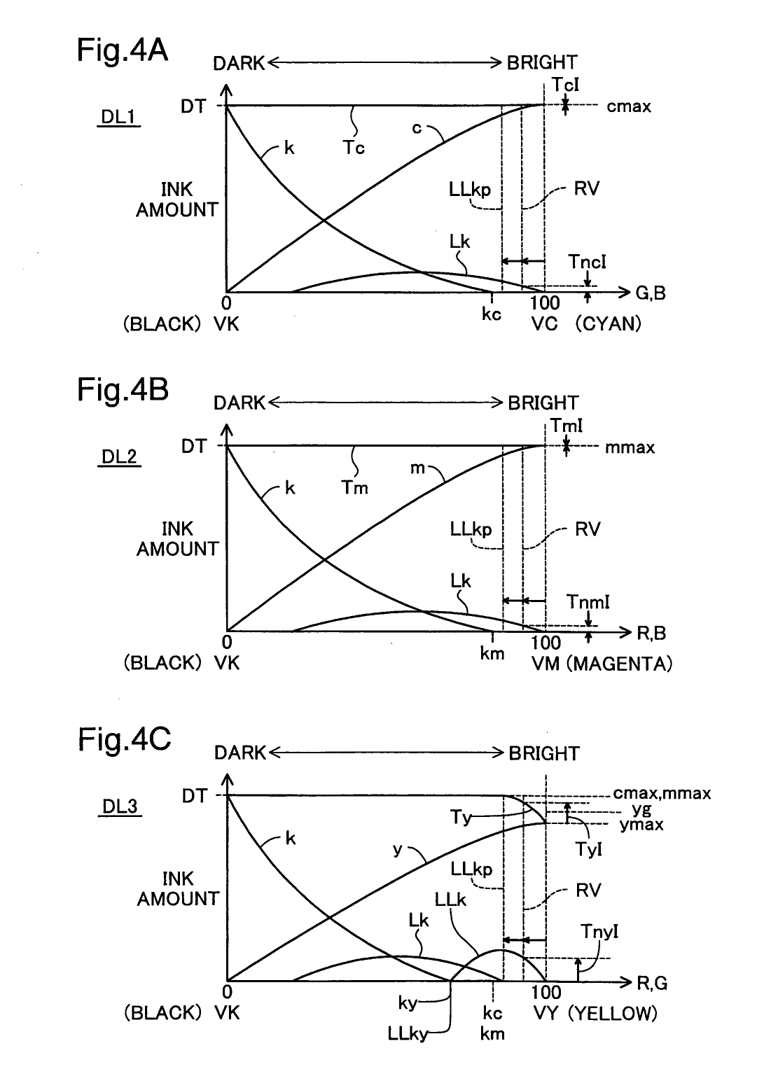

FIGS. 4A-4C are graphs showing an example of the ink amount associated with the colors on the three lines DL1, DL2, and DL3 of the color cube CC (FIG. 2). The horizontal axis shows the position on the line, and the vertical axis shows the ink amount.

FIG. 4A shows the first line DL1. This first line DL1 is a straight line that connects the black vertex VK and the cyan vertex VC (FIG. 2). The position on this line DL1 is represented by the tone value (common value) of the variable two components G and B (the horizontal axis indicates the tone value of the two components G and B). The color on this line DL1 varies between the lowest brightness black (VK) and the high saturation cyan (VC). Here, the larger the variable two components G and B, the higher the brightness is. Furthermore, the color on this line DL1 is reproduced by using the black ink k, the first light black ink Lk and the cyan ink c.

The ink amount of the cyan ink c decreases as the two components G and B decrease. Also, except for the color VK (the two components G and B are zero), the ink amount of the cyan ink c is greater than zero.

In the range where the two components G and B are less than or equal to a specific cyan black generating threshold value kc, the ink amount of the black ink k increases as the two components G and B decrease. In the range where the two components G and B are greater than this threshold value kc, this ink k is not used. Specifically, in the range where the ink amount of the black ink k is greater than zero, the maximum value of the variable two components G and B is the cyan black generating threshold value kc.

Note that the color of the black vertex VK is reproduced by using the black ink k to the maximum limit. Furthermore, to reproduce the lowest brightness black color, the ink amount of the black ink k among the plurality of inks is set to the largest value.

The ink amount of the first light black ink Lk is represented by a smooth curve which covers a partial range including the maximum value (100%) of the two components G and B. The both ends of the curve are zero, and the curve has one peak between them.

With this embodiment, the total ink amount Tc of all the inks is maintained to be almost constant without regard to the magnitude of the two components G and B. However, this total ink amount Tc may vary.

For reproduction of relatively bright colors (colors near the cyan vertex VC), a larger amount of the first light black ink Lk is used than that of the black ink k. By doing this, it is possible to improve the graininess of the cyan near the cyan vertex VC. Meanwhile, for reproduction of relatively dark colors (colors near the black vertex VK), a larger amount of the black ink k is used than that of the first light black ink Lk. By doing this, it is possible to reproduce dark cyan without using an excessive amount of ink.

FIG. 4B shows the second line DL2. This second line DL2 is a straight line that connects the black vertex VK and the magenta vertex VM (FIG. 2). The position on this line DL2 is represented by the tone value (common value) of the variable two components R and B (the horizontal axis indicates the tone value of the two components R and B). The color on this line DL2 varies between the black (VK) and the high saturation magenta (VM). Here, the larger the variable two components R and B, the higher the brightness is. Furthermore, the color on this line DL2 is reproduced by using the black ink k, the first light black ink Lk, and the magenta ink m.

With this embodiment, the ink amount of the black ink k, the first light black ink Lk, and the magenta ink m are respectively set in the same manner as the ink amount of the black ink k, the first light black ink Lk, and the cyan ink c shown in FIG. 4A. As a result, the total ink amount Tm of all the inks is maintained to be almost constant without regard to the magnitude of the two components R and B. However, this total ink amount Tm may vary. Also, to reproduce relatively bright colors (colors near the magenta vertex VM), a larger amount of the first light black ink Lk is used than that of the black ink k. Furthermore, for reproducing the relatively dark colors (colors near the black vertex VK), a larger amount of the black ink k is used than that of the first light black ink Lk.

Note that the black ink k is used in a range where the two components R and B are less than or equal to a specific magenta black generating threshold value km. In the range where the two components R and B are greater than this threshold value km, the black ink k is not used. Specifically, the maximum value of the variable two components R and B in the range where the ink amount of the black ink k is greater than zero is this magenta black generating threshold value km.

FIG. 4C shows the third line DL3. This third line DL3 is a straight line that connects the black vertex VK and the yellow vertex VY (FIG. 2). The position on this line DL3 is represented by the tone value (common value) of the variable two components R and G (the horizontal axis indicates the tone value of the two components R and G). The color on this line DL3 varies between black (VK) and high saturation yellow (VY). Here, the larger the variable two components R and G, the higher the brightness is. Specifically, by lowering the brightness from the yellow vertex VY (maximum yellow color), the color moves from the yellow vertex VY toward the black vertex VK on the line DL3. Also, the color on this line DL3 is reproduced by using the second light black ink LLk in addition to the black ink k, the first light black ink Lk, and the yellow ink y.

The ink amount of the yellow ink y decreases as the two components R and B decrease, in the same way as with the cyan ink c and the magenta ink m shown in FIGS. 4A and 4B.

In the range where the two components R and G are less than or equal to a specific yellow black generating threshold value ky, the ink amount of the black ink k increases as the two components R and G decrease. In the range where the two components R and G are greater than this threshold value ky, this ink k is not used. Specifically, the maximum value of the variable two components R and G in the range where the ink amount of the black ink k is greater than zero is the yellow black generating threshold value ky.

The first light black ink Lk is used in the remaining intermediate range excluding both end parts of the overall range of the two components R and G. The ink amount of this ink Lk is represented by a smooth curve. The both ends of the curve are zero, and the curve has one peak between them.

The second light black ink LLk is not used in a range where the two components R and G are smaller than a specific yellow second black reduction threshold value LLky. In the range from this threshold value LLky up to the maximum value (100%), the ink amount of this light ink LLk is represented by a smooth curve. The both ends of the curve are zero, and the curve has one peak between them. When the two components R and G are a specific value LLkp, the ink amount of this ink LLk is at its maximum. In this way, to reproduce colors for which the common value of the two components R and G (brightness) is higher than the specific value LLky and less than the maximum value (100%), the second light black ink LLk is used. Note that with this embodiment, the yellow black generating threshold value ky and the yellow second black reduction threshold value LLky are set to the same value. However, these threshold values ky and LLky may be different from each other.

With this embodiment, in the range from the value LLkp up to the maximum value of the two components R and G, the total ink amount Ty of all the inks increases as the two components R and G decreases. Furthermore, in the range where the two components R and G are less than or equal to the value LLkp, the total ink amount Ty is maintained to be almost constant. However, the total ink amount Ty may vary.

The ink amount shown in FIG. 4C has the following various characteristics. Specifically, to reproduce relatively bright colors (colors near the yellow vertex VY), a larger amount of the second light black ink LLk is used than those of the black ink k and the first light black ink Lk. The yellow ink y has lower density (is brighter) than those of the cyan ink c and the magenta ink m. As a result, when a small amount of another ink is added in the yellow color of the yellow vertex VY, the added ink dots tend to stand out visually compared to when a small amount of another ink is added near the cyan vertex VC or the magenta vertex VM. Specifically, when another ink (for example, the black ink k or the first light black ink Lk) is mixed in the color reproduced by the yellow ink y, the graininess tend to become rough, compared to when another ink is mixed in a color reproduced by the cyan ink c or the magenta ink m. In light of this, with the embodiment in FIG. 4C, a low brightness yellow close to the yellow vertex VY is reproduced by using the second light black ink LLk. The density of the second light black ink LLk is lower than that of the first light black ink Lk, and the ink dots of the second light black ink LLk do not stand out well visually compared to those of the first light black ink Lk. As a result, it is possible to improve the graininess when the brightness of yellow is decreased.

Also, when the brightness is decreased using this kind of low density ink (for example, the second light black ink LLk), the ink amount is larger compared to when using high density ink (for example the black ink k). Furthermore, the usable ink amount is limited by the duty DT. In light of this, with this embodiment, the yellow maximum ink amount ymax is set to a value smaller than both the cyan maximum ink amount cmax and the magenta maximum ink amount mmax (FIGS. 4A to 4C). As a result, among cyan, magenta, and yellow, that color is the yellow whose difference between the duty ink amount DT and the maximum ink amount (cmax, mmax, and ymax) is the largest. This difference represents the allowed amount for using other inks. By doing this, when decreasing the brightness from the yellow vertex VY, it is possible to use a sufficient amount of the second light black ink LLk to decrease the brightness, compared to when decreasing the brightness from the cyan vertex VC and the magenta vertex VM. Meanwhile, when decreasing the brightness from the cyan vertex VC and the magenta vertex VM, the added ink dots tend not to stand out visually compared to when decreasing the brightness from the yellow vertex VY, so the graininess tend not to become rough even when using the first light black ink Lk. Because of that, the differences between the duty ink amount DT and the maximum ink amounts (cmax and mmax) are smaller than the difference between the duty DT and the yellow maximum ink amount ymax, and the brightness is decreased by using the first light black ink Lk.

In particular, with the embodiment in FIG. 4C, the yellow maximum ink amount ymax is set to a value smaller than the ratio ink amount yg calculated from the gray ratio. Here, the gray ratio means the ratio of the amounts of each ink when reproducing achromatic colors using color mixture (composites) of the cyan ink c, the magenta ink m, and the yellow ink y. Also, the ratio ink amount yg is calculated according to the gray ratio from the maximum ink amount of the higher gray ratio ink among the cyan ink c and the magenta ink m. For example, the gray ratio is assumed to be “cyan ratio cr:magenta ratio mr:yellow ratio yr.” Here, when the cyan ratio cr is greater than the magenta ratio mr, the ratio ink amount yg is calculated using formula 1 below.

Ratio ink amount yg=Yellow ratio yr/Cyan ratio cr*Cyan maximum ink amount cmax (Formula 1)

When the magenta ratio mr is greater than the cyan ratio cr, the following formula 2 is used.

Ratio ink amount yg=Yellow ratio yr/Magenta ratio mr*Magenta maximum ink amount mmax (Formula 2)

To achieve balance of the color reproduction range, the maximum ink amount ratio “cmax:mmax:ymax” is set to the same ratio as the gray ratio. However, with this embodiment, the yellow maximum ink amount ymax is intentionally set to a value smaller than the ratio ink amount yg calculated from the gray ratio. In other words, the yellow maximum ink amount ymax is set to a value smaller than both the ink amount of the yellow ink calculated according to the gray ratio from the magenta maximum ink amount mmax, and the ink amount of the yellow ink calculated according to the gray ratio from the cyan maximum ink amount cmax. As a result, it is possible to use a sufficient amount of the second light black ink LLk to decrease the yellow brightness.

Note that each color component cr, mr, and yr of the gray ratio can be adjusted to various values. For example, by increasing the density of the colorant of the yellow ink y, it is possible to set the yellow ratio yr to a value smaller than the larger one among the other two components cr and mr. By doing this, the amount of the yellow ink y that is used is suppressed, and as a result, it is possible to suppress an excessive total ink amount (the dots of the yellow ink y tend not to stand out easily visually, so the increase in the density of the colorant of the yellow ink y does not cause excessive degradation of the graininess). In this case as well, it is preferable to intentionally set the yellow maximum ink amount ymax to an even smaller value than the ratio ink amount yg calculated from the gray ratio.

Meanwhile, when the brightness is decreased from the cyan vertex VC and the magenta vertex VM, the first light black ink Lk whose density is higher than that of the second light black ink LLk is used. As a result, compared to when the brightness is decreased from the yellow vertex VY, it is possible to decrease the brightness sufficiently using a small amount of the first light black ink Lk. In light of this, by setting the cyan maximum ink amount cmax and the magenta maximum ink amount mmax to a value greater than the yellow maximum ink amount ymax, it is possible to avoid the color reproduction range of cyan and magenta becoming excessively narrow. Note that for the maximum yellow color, the changes in saturation due to varying the maximum ink amount tend not to stand out visually, compared to the maximum cyan color and the maximum magenta color. Therefore, even when the yellow maximum ink amount ymax is set to a value smaller than the other maximum ink amounts cmax and mmax, it is possible to avoid the yellow color reproduction range becoming excessively narrow. Also, by increasing the density of the colorant of the yellow ink y, it is possible to avoid the yellow color reproduction range from becoming excessively narrow.

Also, to reproduce the relatively dark colors (colors near the black vertex VK) in FIG. 4C, a larger amount of the black ink k is used than those of the first light black ink Lk and the second light black ink LLk. By doing this, it is possible to suitably reproduce the dark yellow without using an excessive amount of ink. Also, to reproduce medium range colors (colors between the black vertex VK and the yellow vertex VY), a large amount of the first light black ink Lk having a medium level density is used. By doing this, it is possible to smoothly perform switching between the black ink k and the second light black ink LLk.

Incidentally, the ink amounts shown in FIGS. 4A to 4C have the following characteristics. Specifically, among the respective black generating threshold values kc, km, and ky on the lines DL1, DL2, and DL3, the yellow black generating threshold value ky is the smallest. This means that compared to the maximum cyan color and the maximum magenta color, when the brightness is decreased from the maximum yellow color, dot formation of the black ink k is suppressed. As a result, it is possible to improve the graininess when the yellow brightness is decreased.

The ink amounts shown in FIGS. 4A to 4C also have the following characteristics. Specifically, the non-yellow total increase amount TnyI on the third line DL3 is greater then both the non-cyan total increase amount TncI on the first line DL1 and the non-magenta total increase amount TnmI on the second line DL2. Here, the non-cyan total increase amount TncI means the total increase amount of the inks other than the cyan ink c when the variable two components G and B on the first line DL1 are decreased from the maximum value to the reference value RV (in this case, the increase amount of the first light black ink Lk). Also, the non-magenta total increase amount TnmI means the total increase amount of the inks other than the magenta ink m when the variable two components R and B on the second line DL2 are decreased from the maximum value to the reference value RV (in this case, the increase amount of the first light black ink Lk). Also, the non-yellow total increase amount TnyI means the total increase amount of the inks other than the yellow ink y when the variable two components R and G on the third line DL3 are decreased from the maximum value to the reference value RV (in this case, the increase amount of the second light black ink LLk). The reference value RV can be set to any value within a range from the maximum value to a specified value LLkp. With this embodiment, this specific value LLkp is the value where the ink amount of the second light black ink LLk represents the peak. In this way, when decreasing the brightness of yellow, compared to cyan and magenta, a large amount of additional ink is used. Specifically, many ink dots are formed. As a result, it is possible to improve the graininess when the yellow brightness is decreased.

The ink amounts shown in FIGS. 4A to 4C also have the following characteristics. Specifically, the increase amount TyI of the total ink amount Ty on the third line DL3 is larger than both the increase amount TcI of the total ink amount Tc on the first line DL1 and the increase amount TmI of the total ink amount Tm on the second line DL2. Each increase amount TcI, TmI, and TyI is the increase amount when the variable two components are decreased from the maximum value to the reference value RV (note that with this embodiment, the cyan and magenta total increase amount TcI and TmI are zero). The reference value RV can be set to any value within the range from the maximum value to the specified value LLkp. In this way, when the yellow brightness is decreased, compared to cyan and magenta, the total ink amount of all inks increase more greatly. Specifically, the number of ink dots increases significantly. As a result, it is possible to improve the graininess when the brightness of yellow is decreased.

Incidentally, the ink amount of the other colors within the color cube CC shown in FIG. 2 can be set using various methods. For example, the color on the VC-VB line can be reproduced by replacing part of the ink amount of the cyan ink c in the ink amounts that correspond to the cyan vertex VC with the ink amount of the magenta ink m. It is also possible to set the ink amount, in the same way, for the colors on the VM-VB line, VM-VR line, the VY-VR line, the VY-VG line, and the VC-VG line respectively.

The ink amount can also be set for the colors on the VK-VP, line, the VK-VG line, and the VK-VB line, respectively, in the same way as the embodiment in FIG. 4A. Specifically, the closer to the black vertex VK, the less the ink amount of the chromatic inks is set. Furthermore, the first light black ink Lk is used for relatively bright colors, and the black ink k is used for the relatively dark colors.

Also, the color on the VK-VW line (gray line) can be reproduced by use of the three achromatic inks k, Lk, and LLk according to the brightness in the same way as the embodiment in FIG. 4C. Here, part or all of the respective ink amounts of each of the achromatic inks can also be replaced with composite of chromatic inks. Here, it is preferable to use a composite of the low density inks Lc, Lm, and y for bright grays, and to use composites of high density inks c, m, and y for dark grays.

Note that the correspondence relationships for other colors within the color cube CC can be set by interpolating the correspondence relationships on each line described above. Also, the lookup table 230 includes the correspondence relationships relating to part of the input colors in the color cube CC. When the correspondence relationship of a subject input color is not included in the lookup table 230, the color conversion module 220 sets the ink amounts for the subject input color by interpolating those correspondence relationships included in the lookup table 230 which correspond to some input colors close to the subject input color.

### B. Variations:

Note that, in the elements in each of the embodiments described above, elements other than the elements claimed in the independent claims are additional elements, and may be omitted as appropriate. Also, this invention is not limited to the embodiments and aspects described above, and may also be reduced to practice in various aspects without departing from the spirit thereof, such as the following variations.

### Variations 1:

With the embodiments described above, the ink amount of each ink is not limited to the ink amount shown in FIGS. 3A-3C and FIGS. 4A-4C but can be set to various values. For example, the maximum yellow color may differ from the color of the yellow vertex VY. In this case as well, to reproduce colors in a range where the brightness is decreased from the maximum yellow color and the brightness is higher than a specific value, it is preferable to set the ink amount of each ink so that light inks are used to decrease the brightness in addition to yellow ink. Also, it is preferable for the ink amount of each ink to exhibit the various characteristics described above. Furthermore, it is preferable for the maximum yellow color to be correlated to a point close to the yellow vertex VY (for example, a point in a range where the closest vertex within the color cube CC is the yellow vertex VY). By doing this, it is possible to reproduce colors suitable for the input color. Similarly, the maximum cyan color may be different from the color of the cyan vertex VC and the maximum magenta color may be different from the color of the magenta vertex VM.

Also, with the embodiments described above, the highest saturation cyan color (reproduction color) may be different from at least either one among the maximum cyan color and the color of the cyan vertex VC. In this case as well, it is preferable that the ink whose amount is largest among the plurality of inks to reproduce the highest saturation cyan color is an ink that contains a cyan colorant. By doing this, it is possible to suitably reproduce high saturation cyan color. Also, it is preferable for the highest saturation cyan color to be correlated to a point close to the cyan vertex VC (for example, a point within a range where the closest vertex within the color cube CC is the cyan vertex VC). By doing this, it is possible to reproduce a color suitable for the input color. These are also the same for the magenta color and the yellow color as well.

### Variations 2:

With the embodiments described above, the inks used for printing are not limited to the eight inks shown in FIG. 1, but rather any freely selected inks can be used. For example, it is also possible to use a combination of cyan ink c, light cyan ink Lc, magenta ink m, light magenta ink Lm, yellow ink y, and black ink k. In this case, to reproduce a slightly dark yellow from the yellow vertex VY (or the maximum yellow color), it is preferable to use at least either one among the light cyan ink Lc and the light magenta ink Lm. Also, to improve the image quality, it is also possible to use ink that does not contain a colorant. In this case, it is preferable that each ink amount and the various total ink amounts of the plurality of inks containing colorants (including chromatic inks and achromatic inks) among the plurality of inks used for printing have the characteristics described above.

### Variations 3:

With each of the embodiments described above, not only the second light black ink LLk, but also light inks of various hue other than yellow can be used to reproduce a slightly dark yellow color with the brightness decreased from the maximum yellow color (or the yellow vertex VY). Specifically, when the plurality of useable inks includes a dense ink and a light ink of the same hue different from yellow, that light ink can be used to reproduce a slightly dark yellow color. When it is possible to use three or more inks of different densities with the same hue, it is preferable to use the light ink with the lowest density. Note that in this case, inks other than the highest density ink among inks of the same hue, specifically, inks with a lower density than that of the highest density ink can also be called light inks. Also, the achromatic inks can be described as inks having different hue from yellow. Generally, the achromatic inks can be described as inks having different hue from that of any chromatic inks. Also, the plurality of achromatic inks having densities different from each other can be described as inks having the same hue.

For example, the first light black ink Lk may be used. In this case, the second light black ink LLk may be omitted from the usable inks. Also, chromatic inks may be used instead of achromatic inks. For example, light cyan ink Lc may be used. Also, a light blue ink may be used. It is also possible to use a plurality of types of light inks. For example, it is also possible to use the second light black ink LLk, the light cyan ink Lc, and the light magenta ink Lm. Furthermore, at least either one among a light black ink, a light cyan ink and a light magenta ink may be used.

In any of these cases, it is preferable that the non-yellow total increase amount TnyI be set to a value greater than both the non-cyan total increase amount TncI and the non-magenta total increase amount TnmI. Here, the range where the non-yellow total increase amount TnyI is maintained at a value greater than the other total increase amounts TncI and TnmI is not limited to the range from the value LLkp to the maximum value (100%) shown in FIGS. 4A to 4C, but it is also possible to use any partial range including the maximum values of the variable two components (hereafter, that range is termed “other ink brightness range’). In this way, it is possible to improve the graininess when the yellow brightness is decreased if the non-yellow total increase amount TnyI is greater than both the non-cyan total increase amount TncI and the non-magenta total increase amount TnmI in the relatively bright partial range. In this case, the established ink amounts do not need to exhibit the other characteristics described above. For example, the yellow maximum ink amount ymax may be set to a value greater than at least either one among the cyan maximum ink amount cmax and the magenta maximum ink amount mmax.

Also, in any of these cases, it is preferable that the yellow total increase amount TyI is set to a value larger than both the cyan total increase amount TcI and the magenta total increase amount TmI. Here, the range where the yellow total increase amount TyI is maintained at a value larger than both of the other total increase amounts TcI and TmI is not limited to the range from the value LLkp to the maximum value (100%), but it is possible to use any partial range including the maximum value of the variable two components (hereafter, that range is termed “total ink brightness range”). In this way, it is possible to improve the graininess when the yellow brightness is decreased if the yellow total increase amount TyI is greater than both the cyan total increase amount TcI and the magenta total increase amount TmI in the relatively bright partial range. In this case, the established ink amounts do not need to exhibit the other characteristics described above. Furthermore, the “total ink brightness range” may be different from the “other ink brightness range” described above.

Also, in any of these cases, it is preferable that the yellow maximum ink amount ymax be smaller than both of the cyan maximum ink amount cmax and the magenta maximum ink amount mmax. By doing this, by using the light ink, it is possible to improve the graininess when the yellow brightness is decreased. In this case, the established ink amounts do not need to exhibit the other characteristics described above. For example, the yellow maximum ink amount ymax may be set to a value larger than the ratio ink amount yg calculated from the gray ratio. The non-yellow total increase amount TnyI may be set to a value smaller than at least either one among the non-cyan total increase amount TncI and the non-magenta total increase amount TnmI. Also, the yellow black generating threshold value ky may be greater than at least either one among the cyan black generating threshold value kc and the magenta black generating threshold value km.

Also, in any of these cases, it is preferable that the yellow black generating threshold value ky is smaller than both of the cyan black generating threshold value kc and the magenta black generating threshold value km. By doing this, the black ink k dot formation is suppressed, so it is possible to improve the graininess when the yellow brightness is decreased. In this case, it is possible to use various light inks to reproduce a color for which the two components R and G on the third line DL3 are larger than or equal to a specific value and less than the maximum value (100%). Also, in this case, the established ink amounts do not need to exhibit the other characteristics described above. For example, the yellow maximum ink amount ymax may be set to a value greater than at least either one among the cyan maximum ink amount cmax and the magenta maximum ink amount mmax. The yellow maximum ink amount ymax may be set to a value greater than the ratio ink amount yg calculated from the gray ratio. Also, the non-yellow total increase amount TnyI may be set to a value smaller than at least either one among the non-cyan total increase amount TncI and non-magenta total increase amount TnmI.

### Variations 4:

With the embodiments described above, the maximum ink amount may be different for each ink not only for the yellow ink y, but in regards to any other chromatic ink as well. For example, the cyan maximum ink amount cmax may be set to a value smaller than the magenta maximum ink amount mmax. In this case, it is possible to use a sufficient amount of low density ink (for example, light ink) when the brightness is decreased from the maximum cyan color, so it is possible to improve the cyan color graininess. Here, various light inks with a different hue than cyan can be used as the light ink (for example, the second light black ink LLk or the light magenta ink Lm). Conversely, the magenta maximum ink amount mmax may be set to a value smaller than the cyan maximum ink amount cmax. By doing this, it is possible to improve the graininess of the magenta color.

In any of these cases, it is preferable that the maximum ink amount of a first chromatic ink is smaller than the maximum ink amount of a second chromatic ink. Here, the first chromatic ink means a chromatic ink for which ink dots of the other inks (for example, black ink k) tend to stand out visually easily among ink dots of that chromatic ink. The second chromatic ink means a chromatic ink for which the ink dots of the other inks tend not to stand out visually among ink dots of that chromatic ink. If the maximum ink amount of the ink for which the dots of the other inks tend to stand out easily visually is set to a small value, it is possible to use a low density ink (for example, a light ink) with sufficient amount to decrease the brightness. As a result, it is possible to suppress the graininess from becoming rough. Meanwhile, if the maximum ink amount of the ink for which the dots of the other inks tend not to stand out easily visually is set to a large value, it is possible to reproduce high saturation colors. For example, when ink dots of the other inks among ink dots of the cyan ink c tend to stand out easily compared to ink dots of the other inks among ink dots of the magenta ink m, it is preferable that the cyan maximum ink amount cmax be smaller than the magenta maximum ink amount mmax. In the reverse case, it is preferable that the magenta maximum ink amount mmax be smaller than the cyan maximum ink amount cmax. Note that when it is possible to use a plurality of chromatic inks of different densities with the same hue, the maximum ink amount of the ink with the highest density is preferably set as described above.

Note that for comparison of the ease of standing out visually of dots of the other inks (for example, black ink k), it is possible to use the color difference of the color reproduced on the printing medium. The smaller the change in color caused by adding the black ink k, the less likely dots of the black ink k stand out visually. Specifically, when comparing a first ink and a second ink, an equal amount of the first ink and the second ink is respectively ejected on the same printing medium. Next, dots of an equal amount of the black ink k are added respectively to the two reproduced colors (it is preferable that the amount of the black ink k be smaller than both the amounts of the first ink and the second ink). The smaller the color difference between before and after this addition, the less likely the dots of the black ink k stand out visually. Note that as this kind of color difference, it is possible to use the color difference that can be obtained from the color measurement results and the CIE94 color difference formula. The standard light D65 can be used for color measurement.

### Variations 5:

With each of the embodiments described above, the ink amounts are set focusing attention on the color whose yellow ink amount per unit area is maximum (maximum yellow), the color whose cyan ink amount per unit area is maximum (maximum cyan), and the color whose magenta ink amount per unit area is maximum (maximum magenta) in the overall color reproduction range by printing. However, it is also possible to set the ink amounts focusing attention on colors selected according to other conditions. For example, it is also possible to set the ink amounts focusing attention on a yellow color of interest, a cyan color of interest and a magenta color of interest. The yellow color of interest may be the color whose hue is the same or almost the same as that of the yellow ink and whose brightness is nearly the median of the domain (the overall range) of the brightness. The cyan color of interest may be the color whose hue is the same or almost the same as that of the cyan ink and whose brightness is nearly the median of the domain of the brightness. The magenta color of interest may be the color whose hue is the same or almost the same as that of the magenta ink and whose brightness is at nearly the median of the domain of the brightness. The brightness of the yellow color of interest may be the same as the median of the domain of the brightness. The brightness of the cyan color of interest may be the same as the median of the domain of the brightness. The brightness of the magenta color of interest may be the same as the median of the domain of the brightness. Here, as these colors of interest, it is preferable to use colors with the highest saturation. It is also possible to set the ink amounts focusing attention on the color having the same or almost the same hue as that of the yellow ink and highest saturation (yellow color of interest), the color having the same or almost the same hue as that of the cyan ink and highest saturation (cyan color of interest), and the color having the same or almost the same hue as that of the magenta ink and highest saturation (magenta color of interest). By using these conditions, colors respectively close to the cyan vertex VC, the magenta vertex VM, and the yellow vertex VY are used as the three colors of interest.

As the hue, brightness, and saturation, unless otherwise noted, it is possible to use the respective indices of the hue, brightness, and saturation for the color cube CC shown in FIG. 2. This is the same for the various characteristics described later.

Here, it is preferable that the yellow ink amount (termed first ink amount) used to reproduce (print) the yellow color of interest be smaller than both the cyan ink amount (termed second ink amount) used to reproduce (print) the cyan color of interest and the magenta ink amount (termed third ink amount) used to reproduce (print) the magenta color of interest. This characteristic is the same characteristic as the magnitude relationship of the maximum ink amounts cmax, mmax, and ymax for the embodiments described above.

Also, it is preferable that the ink amounts have the following characteristics when printing the respective three gradations in which a color changes from the respective three colors of interest to a black color (for example, a black of the lowest brightness, the black vertex VK in the color cube CC). Specifically, it is preferable that the total increase amount of the inks other than yellow ink on the black yellow gradation be greater than both the total increase amount of the inks other than the cyan ink on the black cyan gradation and the total increase amount of the inks other than the magenta ink on the black magenta gradation. Each total increase amount represents a total increase amount when the color changes from each color of interest to a color having a specific brightness (lower brightness). This characteristic is the same characteristic as the magnitude relationship between the total increase amounts TncI, TnmI, and TnyI shown in FIGS. 4A-4C.

Here, as the three gradations, it is preferable to use the three gradations on the three straight lines which connect the three colors of interest and the black vertex VK on the color cube CC respectively. For example, when using the respective colors of the cyan vertex VC, the magenta vertex VM, and the yellow vertex VY as the three colors of interest, it is possible to use the three gradations on the thee lines DL1, DL2, and DL3 described with FIG. 2 and FIGS. 4A-4C as the three gradations. Also, as a range of the specific brightness showing this kind of characteristic, the same as the reference value RV described with FIGS. 4A-4C, it is possible to use a brightness range from a specific value brighter than the black vertex VK to the lowest brightness among the brightness of the three colors of interest.

Also, for the respective printing of the three gradations, it is preferable that the ink amounts have the following characteristics when the color changes from each color of interest to the specific brightness color. Specifically, the total increase amount of all inks on the black yellow gradation is preferable greater than both the total increase amount of all inks on the black cyan gradation and the total increase amount of all inks on the black magenta gradation. This characteristic is the same characteristic as the magnitude relationship of the total increase amounts TcI, TmI, and Tyl shown in FIGS. 4A-4C. Also, as a range of the specific brightness showing this kind of characteristic, the same as the reference value RV described with FIGS. 4A-4C, it is possible to use a brightness range from a specific value brighter than the black vertex VK to the lowest brightness among the brightness of the three colors of interest.

It is also preferable that the first ink amount of the yellow color of interest be set to a value smaller than both a ink amount of the yellow ink calculated according to the gray ratio from the second ink amount of the cyan color of interest and a yellow ink amount calculated according to the gray ratio from the third ink amount of the magenta color of interest.

Also, there are cases when the plurality of usable inks includes black ink in addition to the cyan ink, magenta ink, and yellow ink. In this case, it is preferable that the lowest brightness of color to be printed without using black ink is set as follows, on the respective three gradations in which a color changes from the respective three colors of interest to a black (for example, a black with the lowest brightness, the black vertex VK in the color cube CC). Specifically, it is preferable that the lowest brightness on the black yellow gradation be darker than both the lowest brightness on the black cyan gradation and the lowest brightness on the black magenta gradation. This characteristic is the same characteristic as the magnitude relationship of the black generating threshold values kc, km, and ky shown in FIGS. 4A-4C. Note that when it is possible to use a plurality of achromatic inks with mutually different densities, it is possible to compare the lowest brightness of color to be printed without using the highest density achromatic ink (with the embodiments described above, the black ink k).

There are also cases when the plurality of usable inks includes a dense ink and a light ink having different densities and the same hue different from yellow. In this case, to reproduce a color in a range where the color has the brightness decreased from the yellow color of interest and the brightness is higher than a specific value, it is preferable to use the light ink to decrease the brightness in addition to the yellow ink. Furthermore, this dense ink may be black ink, and the light ink may be light black ink.

When setting the ink amounts, it is possible to employ a combination of characteristics selected freely from among the various characteristics described with this variation. It is also possible to obtain the same advantages as the embodiments described above if the various characteristics described with this variation are employed.

There are also cases when it is possible to use a plurality of inks having the same hue of cyan and mutually different densities. In such a case, it is acceptable to employ the following ink as the cyan ink for the various characteristics of the ink amounts described with each of the embodiments (the first embodiment described above, this variation and the other variations). Specifically, it is possible to employ an ink with hue of cyan whose ink amount is largest among a plurality of inks with hue of cyan when printing the highest saturation cyan color to be reproduced on the printing medium (with the embodiments described above, the cyan ink c). This is also the same for the yellow ink and the magenta ink.

### Variations 6:

As the aspects of the printing control device, it is possible to employ the following kind of aspect. For example, a printing control device controls a printing engine that executes printing using a plurality of inks. The printing control device is equipped with a printing control module that controls a respective amount (amount used) of the plurality of inks. The plurality of inks includes a cyan ink, a magenta ink, and a yellow ink. The printing control module controls the ink amounts by a process of converting first image data into second image data. The first image data is represented in an input color system representing a color using three components of R component, G component, and B component. The second image data is represented in an ink color system representing a color using an ink amount of each of the inks. Furthermore, the printing control module controls the ink amounts so as to meet the following condition: a total increase amount of inks other than the yellow ink on a black yellow line is greater than both a total increase amount of inks other than the cyan ink on a black cyan line and a total increase amount of inks other than the magenta ink on a black magenta line when decreasing a common value of variable two components on each line from a maximum value to a reference value. The black cyan line connects a black vertex and a cyan vertex, the black magenta line connects the black vertex and a magenta vertex and the black yellow line connects the black vertex and a yellow vertex in the color cube of the input color system. The reference value is within a range above a specific value greater than zero.

It is also possible to employ the following kind of aspect. A printing control device controls a printing engine that executes printing using a plurality of inks. The printing control device is equipped with a printing control module that controls a respective amount (amount used) of the plurality of inks. The plurality of inks includes a cyan ink, a magenta ink, a yellow ink, and a black ink. The printing control module controls the ink amounts by a process of converting first image data into second image data. The first image data is represented in an input color system representing a color using three components of R component, G component, and B component. The second image data is represented in an ink color system representing a color using an ink amount of each of the inks. The printing control module controls the ink amounts so as to meet the following condition: a black use range is set for each of a black cyan line, a black magenta line and a black yellow line. The black use range is a range where an ink amount of the black ink is greater than zero. The black cyan line connects a black vertex and a cyan vertex, the black magenta line connects the black vertex and a magenta vertex and the black yellow line connects the black vertex and a yellow vertex in the color cube of the input color system. Furthermore, the printing control module controls the ink amounts so as to meet the following condition: a black generating threshold value on the black yellow line is closer to the black vertex than both of a black generating threshold value on the black cyan line and a black generating threshold value on the black magenta line. The term “black generating threshold value” denotes a maximum common value of variable two components on a line within the black use range. Note that when it is possible to use a plurality of achromatic inks of mutually different densities, it is possible to compare the generating threshold value of the highest density achromatic ink (with the embodiments described above, the black ink k).

Here, there are cases when it is possible to use a dense ink and a light ink having different densities and the same hue different from yellow. In this case, it is preferable that the printing control module controls the ink amounts so as to meet the following condition: on the black yellow line, to reproduce a color in a range where a common value of variable two components R and G is greater than a specific value and less than a maximum value, the light ink is used to decrease brightness in addition to the yellow ink.

### Variations 7:

With the embodiments described above, the color system of the input image data is not limited to the RGB color system; any color system would be acceptable. In any case, it is preferable for the ink amounts for reproducing the various colors to have the various characteristics described above. Note that with the embodiments described above, the various characteristics are described by representing the printing color reproduction range in the RGB color system. To confirm that the ink amounts used for actual printing have the characteristics described above, it is preferable to use printing results obtained using the input image data represented in the RGB color system. Here, the printing device sometimes includes various printing modes (color adjustment modes). When this kind of printing device is used, it is preferable to use the mode of no color adjustment. “No color adjustment” means not performing intentional color adjustment.

### Variations 8:

With the embodiments described above, the configuration for determining the correspondence relationship between the input color system and the ink color system is not limited to the configuration of using the lookup table 230; various configurations would be acceptable. For example, it is also possible to determine the correspondence relationship using numerical functions. In any case, it is preferable to prepare the correspondence relationship between the input color system and the ink color system for each combination of printing medium types and useable inks.

### Variations 9:

With the embodiments described above, the configuration of the printing control module 202 is not limited to the configuration shown in FIG. 1; various configurations would be acceptable. For example, the process may progress in order of the color conversion module 220, the resolution conversion module 210, and the printing data generating module 240. Also, the resolution conversion module 210 may be omitted.

Also, the configuration of the printing device is not limited to the configuration shown in FIG. 1; various configurations would be acceptable. For example, it is also possible to use a configuration capable of printing alone without connecting to an external computer. In this case, as the printing control device 200, it is also possible to use dedicated electronic circuitry such as ASIC (Application Specific Integrated Circuits).

### Variations 10:

With the embodiments described above, as the printing engine 300, it is possible to use various printing mechanisms. For example, it is also possible to use a mechanism that executes printing by moving both the printing head PH and the printing medium PM. It is also possible to use a mechanism that executes printing by using a printing head PH including plural ink ejecting nozzles for one whole line, and moves the printing medium PM without moving the printing head PH. Furthermore, not only a printing mechanism that ejects ink drops, but it is also possible to use various printing mechanisms. For example, it is also possible to use a printing mechanism that forms an image by transferring and fusing toner onto the printing medium.

### Variations 11:

With each of the embodiments described above, it is possible to replace some configuration implemented with hardware by using software, and conversely, to replace some configuration implemented with software by using hardware. For example, the functions of the color conversion module 220 of FIG. 1 can also be implemented using hardware circuitry including logic circuitry.

Also, when part or all of the functions of this invention are implemented using software, that software (computer program) can be provided in a form stored in a computer readable recording medium. A “computer readable recording medium” is not limited to a portable recording medium such as a flexible disk or CD-ROM, but also includes various types of internal storage devices such as RAM, ROM or the like and various types of external storage devices fixed to a computer such as, a hard disk, or the like.

### Other Variations:

Various aspects of the invention are previously discussed in this specification. Furthermore, it is possible to employ the following aspect. In an aspect, a printing apparatus for printing using a plurality of inks includes a printing control module. The printing control module is configured to control respective amounts of the plurality of inks. The plurality of inks includes a cyan ink, a magenta ink and a yellow ink. The printing control module controls the respective amounts of the plurality of inks so as to meet the following condition: a first total increase amount is larger than both a second total increase amount and a third total increase amount when printing a black yellow gradation, a black cyan gradation and a black magenta gradation.

The first total increase amount is a total increase amount of inks other than the yellow ink when a color changes on the black yellow gradation from a yellow color of interest to a color having specific lower brightness. The black yellow gradation is a gradation in which a color changes from the yellow color of interest to a black color. The yellow color of interest has the same or almost the same hue as hue of the yellow ink and brightness that is nearly a median of a domain of the brightness.

The second total increase amount is a total increase amount of inks other than the cyan ink when a color changes on the black cyan gradation from a cyan color of interest to a color having the specific lower brightness. The black cyan gradation is a gradation in which a color changes from the cyan color of interest to the black color. The cyan color of interest has the same or almost the same hue as hue of the cyan ink and brightness that is nearly a median of the domain of the brightness.

The third total increase amount is a total increase amount of inks other than the magenta ink when a color changes on the black magenta gradation from a magenta color of interest to a color having the specific lower brightness. The black magenta gradation being a gradation in which a color changes from the magenta color of interest to the black color. The magenta color of interest has the same or almost the same hue as hue of the magenta ink and brightness that is nearly a median of the domain of the brightness.

In this aspect, the brightness of the yellow color of interest may be the same as the median of the domain of the brightness. The brightness of the cyan color of interest may be the same as the median of the domain of the brightness. The brightness of the magenta color of interest may be the same as the median of the domain of the brightness.

According to this aspect, the total increase amount of the inks other than the yellow ink when decreasing the brightness from yellow on the black yellow gradation is set to a value greater than both the total increase amount of the inks other than the cyan ink when decreasing the brightness from cyan on the black cyan gradation and the total increase amount of the inks other than the magenta ink when decreasing the brightness from magenta on the black magenta gradation. Then, it is possible to improve the graininess when the yellow brightness is decreased.

Various aspects of the invention are previously discussed in this specification. In the various aspects, the printing control module preferably controls the respective amounts of the plurality of inks so as to meet the following condition: a first total increase amount is larger than both a second total increase amount and a third total increase amount when printing a black yellow gradation, a black cyan gradation and a black magenta gradation.

The first total increase amount is a total increase amount of inks other than the yellow ink when a color changes on the black yellow gradation from a yellow color of interest to a color having specific lower brightness. The black yellow gradation is a gradation in which a color changes from the yellow color of interest to a black color. The yellow color of interest is a color whose yellow ink amount is set to the first ink amount.

The second total increase amount is a total increase amount of inks other than the cyan ink when a color changes on the black cyan gradation from a cyan color of interest to a color having the specific lower brightness. The black cyan gradation being a gradation in which a color changes from the cyan color of interest to the black color. The cyan color of interest is a color whose cyan ink amount is set to the second ink amount.

The third total increase amount is a total increase amount of inks other than the magenta ink when a color changes on the black magenta gradation from a magenta color of interest to a color having the specific lower brightness. The black magenta gradation being a gradation in which a color changes from the magenta color of interest to the black color. The magenta color of interest is a color whose magenta ink amount is set to the third ink amount.

With this configuration, the total increase amount of the ink other than the yellow ink by decreasing the brightness from yellow on the black yellow gradation is set to a value larger than both the total increase amount of the ink other than the cyan ink by decreasing the brightness from cyan on the black cyan gradation and the total increase amount of the ink other than the magenta ink by decreasing the brightness from magenta on the black magenta gradation. So it is possible to improve the graininess when the yellow brightness is decreased.

In the various aspects, the printing control module preferably controls the respective amounts of the plurality of inks so as to meet the following condition: the first ink amount is smaller than both an yellow ink amount calculated according to a gray ratio from the second ink amount and an yellow ink amount calculated according to the gray ratio from the third ink amount. The gray ratio represents ratio of ink amounts of the cyan ink, the magenta ink and the yellow ink when reproducing achromatic color using color mixture of the cyan ink, the magenta ink and the yellow ink.

With this configuration, the ink amount of each ink is set so that the first ink amount relating to the yellow ink is smaller than the ink amount calculated according to the gray ratio, so it is possible to use a sufficient amount of a light ink to reproduce a color whose brightness is decreased from the yellow color whose yellow ink amount is set to the first ink amount.

In the various aspects, the plurality of inks preferably includes a dense ink and a light ink having different densities and the same hue different from yellow, and the printing control module preferably controls the respective amounts of the plurality of inks so as to meet the following condition: in order to reproduce a color in a range where the brightness is decreased from a yellow color of interest and the brightness is higher than a specific value, the light ink is used to decrease the brightness in addition to the yellow ink. The yellow color of interest is a color whose yellow ink amount is set to the first ink amount.

With this configuration, it is possible to improve the graininess by reproducing the color whose brightness is slightly decreased from the yellow color of interest by using a light ink.

Furthermore, the dense ink preferably includes at lease either one among a black ink, a cyan ink and a magenta ink, and the light ink preferably includes a light ink of each dense ink.

With this configuration, it is possible to suitably reproduce the color whose brightness is decreased from yellow by using the light ink.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A printing apparatus for printing using a plurality of inks, comprising:
a printing control module configured to control respective amounts of the plurality of inks, wherein
the plurality of inks includes a cyan ink, a magenta ink and a yellow ink, and
the printing control module controls the respective amounts of the plurality of inks so as to meet the following condition:
a first ink amount is smaller than both a second ink amount and a third ink amount, wherein:
the first ink amount is an amount of the yellow ink per unit area when printing a first color, the first color having the same or almost the same hue as hue of the yellow ink and brightness that is nearly a median of a domain of the brightness;
the second ink amount is an amount of the cyan ink per unit area when printing a second color, the second color having the same or almost the same hue as hue of the cyan ink and brightness that is nearly the median of the domain of the brightness; and
the third ink amount is an amount of the magenta ink per unit area when printing a third color, the third color having the same or almost the same hue as hue of the magenta ink and brightness that is nearly the median of the domain of the brightness.

2. A printing apparatus for printing using a plurality of inks, comprising:
a printing control module configured to control respective amounts of the plurality of inks, wherein
the plurality of inks includes a cyan ink, a magenta ink, and a yellow ink, and
the printing control module controls respective amounts of the plurality of inks so as to meet the following condition:
a first ink amount is smaller than both a second ink amount and a third ink amount, wherein:
the first ink amount is an amount of the yellow ink per unit area when printing a first color, the first color having the same or almost the same hue as hue of the yellow ink and highest saturation;
the second ink amount is an amount of the cyan ink per unit area when printing a second color, the second color having the same or almost the same hue as hue of the cyan ink and highest saturation; and
the third ink amount is an amount of the magenta ink per unit area when printing a third color, the third color having the same or almost the same hue as hue of the magenta ink and highest saturation.

3. A printing apparatus for printing using a plurality of inks, comprising:
a printing control module configured to control respective amounts of the plurality of inks, wherein
the plurality of inks includes a cyan ink, a magenta ink, and a yellow ink, and
the printing control module controls the respective amounts of the plurality of inks so as to meet the following condition:
a first ink amount is smaller than both a second ink amount and a third ink amount, the first ink amount being maximum ink amount of the yellow ink, the second ink amount being maximum ink amount of the cyan ink, the third ink amount being maximum ink amount of the magenta ink, the first, the second and the third ink amount respectively representing maximum ink amount per unit area in an overall color reproduction range of printing.

4. The printing apparatus in accordance with claim 1, wherein
the printing control module controls the respective amounts of the plurality of inks so as to meet the following condition:
a first total increase amount is larger than both a second total increase amount and a third total increase amount when printing a black yellow gradation, a black cyan gradation and a black magenta gradation, wherein:
the first total increase amount is a total increase amount of inks other than the yellow ink when a color changes on the black yellow gradation from a yellow color of interest to a color having specific lower brightness, the black yellow gradation being a gradation in which a color changes from the yellow color of interest to a black color, the yellow color of interest being a color whose yellow ink amount is set to the first ink amount;
the second total increase amount is a total increase amount of inks other than the cyan ink when a color changes on the black cyan gradation from a cyan color of interest to a color having the specific lower brightness, the black cyan gradation being a gradation in which a color changes from the cyan color of interest to the black color, the cyan color of interest being a color whose cyan ink amount is set to the second ink amount; and
the third total increase amount is a total increase amount of inks other than the magenta ink when a color changes on the black magenta gradation from a magenta color of interest to a color having the specific lower brightness, the black magenta gradation being a gradation in which a color changes from the magenta color of interest to the black color, the magenta color of interest being a color whose magenta ink amount is set to the third ink amount.

5. The printing apparatus in accordance with claim 1, wherein
the printing control module controls the respective amounts of the plurality of inks so as to meet the following condition:
the first ink amount is smaller than both an yellow ink amount calculated according to a gray ratio from the second ink amount and an yellow ink amount calculated according to the gray ratio from the third ink amount, the gray ratio representing ratio of ink amounts of the cyan ink, the magenta ink and the yellow ink when reproducing achromatic color using color mixture of the cyan ink, the magenta ink and the yellow ink.

6. The printing apparatus in accordance with claim 1, wherein
the plurality of inks includes a dense ink and a light ink having different densities and the same hue different from yellow,
the printing control module controls the respective amounts of the plurality of inks so as to meet the following condition:
in order to reproduce a color in a range where the brightness is decreased from a yellow color of interest and the brightness is higher than a specific value, the light ink is used to decrease the brightness in addition to the yellow ink, the yellow color of interest being a color whose yellow ink amount is set to the first ink amount.

7. The printing apparatus in accordance with claim 6, wherein
the dense ink includes at lease either one among a black ink, a cyan ink and a magenta ink, and
the light ink includes a light ink of each dense ink.

8. A printing apparatus for printing using a plurality of inks, comprising:
a printing control module configured to control respective amounts of the plurality of inks, wherein
the plurality of inks includes a cyan ink, a magenta ink, a yellow ink, and a black ink. and
the printing control module controls the respective amounts of the plurality of inks so as to meet the following condition:
a first lowest brightness is lower than both a second lowest brightness and a third lowest brightness when printing a black yellow gradation, a black cyan gradation and a black magenta gradation, wherein:
the first lowest brightness is lowest brightness of color to be printed without using black ink on the black yellow gradation, the black yellow gradation being a gradation in which a color changes from a yellow color of interest to a black color, the yellow color of interest having the same or almost the same hue as hue of the yellow ink and brightness that is nearly a median of a domain of the brightness;
the second lowest brightness is lowest brightness of color to be printed without using black ink on the black cyan gradation, the black cyan gradation being a gradation in which a color changes from a cyan color of interest to the black color, the cyan color of interest having the same or almost the same hue as hue of the cyan ink and brightness that is nearly a median of the domain of the brightness; and
the third lowest brightness is lowest brightness of color to be printed without using black ink on the black magenta gradation, the black magenta gradation being a gradation in which a color changes from a magenta color of interest to the black color, the magenta color of interest having the same or almost the same hue as hue of the magenta ink and brightness that is nearly a median of the domain of the brightness.
